(19) United States
(12) Patent Application Publication
(10) Pub. No.: US 2025/0347445 A1
(43) Pub. Date: Nov. 13, 2025

(54) METHODS AND SYSTEMS FOR CONSTRUCTING AND OPERATING A SYSTEM FOR HEAT TRANSFER FROM GEOTHERMAL WELLS

(71) Applicant: GreenFire Energy Inc.

(72) Inventor: Greg Szutiak, Walnut Creek, CA (US)

(73) Assignee: GreenFire Energy Inc., (US)

(21) Appl. No.: 19/203,055

(22) Filed: May 8, 2025

Related U.S. Application Data
(60) Provisional application No. 63/644,354, filed on May 8, 2024.

(51) Int. Cl. F24T 10/13; E21B 43/10; F24T 50/00

(52) U.S. Cl. CPC F24T 10/13; E21B 43/108; F24T 50/00

(57) ABSTRACT

Methods and systems for constructing an enhanced closed-loop geothermal system for heat transfer from a region of a subsurface. The method may include obtaining a first wellbore extending from a surface and penetrating the region of the subsurface. The method further includes enlarging at least a first portion of the first wellbore to a first pre-determined wellbore diameter and inserting a casing string having an expandable casing section into the first wellbore such that the expandable casing section is disposed within the first portion. The method also includes expanding the expandable casing section within the first portion and inserting a closed-loop geothermal system having a fluid conduit into the first wellbore yielding the enhanced closed-loop geothermal system.

### BACKGROUND

Geothermal production systems extract heat from the subsurface. This enables geothermal systems to produce power at any time during the day or night unlike other renewable energy sources such as wind and solar. However, the essential challenge of closed-loop geothermal systems using downhole heat exchangers is extracting enough heat from the subsurface to ensure the system produces the requisite amount of energy over decades of use. Two limiting determinants of heat transfer are the flow of geothermal fluid flowing from the hot subsurface rock formation to the surface of the heat exchanger and the “airgap” distance between the rock and the downhole heat exchanger.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a method for constructing an enhanced closed-loop geothermal system for heat transfer from a region of a subsurface. The method includes obtaining a first wellbore extending from a surface and penetrating the region of the subsurface. The method further includes enlarging at least a first portion of the first wellbore to a first pre-determined wellbore diameter and inserting a casing string having an expandable casing section into the first wellbore such that the expandable casing section is disposed within the first portion. The method also includes expanding the expandable casing section within the first portion and inserting a closed-loop geothermal system having a fluid conduit into the first wellbore yielding the enhanced closed-loop geothermal system.

In some aspects, the techniques described herein relate to a system for constructing an enhanced closed-loop geothermal system for heat transfer from a region of a subsurface. The system for constructing includes a first wellbore, an enlarging system, and an insertion rig. The first wellbore extends from a surface and penetrates the region of the subsurface. The enlarging system is configured to enlarge at least a first portion of the first wellbore. The insertion rig is configured to insert a casing string having an expandable casing section into the first wellbore such that the expandable casing section is disposed within the first portion. The expandable casing section is configured to expand within the first portion. The insertion rig is further configured to insert a closed-loop geothermal system having a fluid conduit into the first wellbore yielding the enhanced closed-loop geothermal system.

In some aspects, the techniques described herein relate to an enhanced closed-loop geothermal system for heat transfer from a region of a subsurface. The enhanced closed-loop geothermal system includes a wellbore, a casing string, and a closed-loop geothermal system. The wellbore extends from a surface and penetrates the region of the subsurface. The wellbore includes a first portion that has been enlarged to a first pre-determined wellbore diameter using an enlarging system. The casing string has an expanded casing section that has been inserted into the wellbore such that the expanded casing section has been disposed within the first portion. The expanded casing section was expanded after disposition within the first portion. The closed-loop geothermal system has been inserted into the wellbore. The closed-loop geothermal system includes an uphole heat exchanger, a downhole heat exchanger disposed within the wellbore, and a fluid conduit disposed in the wellbore. The fluid conduit is configured to channel cool working fluid from the uphole heat exchanger to the downhole heat exchanger and hot fluid from the downhole heat exchanger to the uphole heat exchanger.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a drilling system undergoing a drilling operation according to a wellbore drilling plan developed at least in part by a well planning system in accordance with one or more embodiments.

FIG. 2 shows a perspective view of an enlarging system that may be used in relation to various embodiments.

FIG. 3 depicts an enhanced closed-loop geothermal system in accordance with one or more embodiments.

FIG. 4A depicts a partial view of an enhanced closed-loop geothermal system for heat transfer using an expandable casing section in accordance with one or more embodiments.

FIG. 4B depicts a partial view of an enhanced closed-loop geothermal system for heat transfer using an expandable casing section in accordance with one or more embodiments.

FIG. 5 depicts a partial view of an enhanced closed-loop geothermal system for heat transfer using an expandable casing section in accordance with one or more embodiments.

FIG. 6 depicts a partial view of an enhanced closed-loop geothermal system for heat transfer using an expandable casing section in accordance with one or more embodiments.

FIG. 7 depicts an expandable casing section used in an enhanced closed-loop geothermal system in accordance with one or more embodiments.

FIG. 8 depicts a partial view of an insulated fluid conduit having insulated connection sleeves of an enhanced closed-loop geothermal system in accordance with one or more embodiments.

FIG. 9 is a flowchart depicting a method for constructing an enhanced closed-loop geothermal system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details, or with other methods, components, materials, and so forth. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precedes) the second element in an ordering of elements.

It is to be understood that the singular forms “a,” “an,” and “the” include plural referents unless the context clearly dictates otherwise. Thus, for example, reference to “a fluid conduit” includes reference to one or more of such fluid conduits.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

As used herein, the term “coupled” or “coupled to” or “connected” or “connected to” “attached” or “attached to” may indicate establishing either a direct or indirect connection and is not limited to either unless expressly referenced as such.

As used herein, fluids may refer to slurries, liquids, gases, and/or mixtures thereof. It is to be further understood that the various embodiments described herein may be used in various stages of a well (land and/or offshore), such as rig site preparation, drilling, completion, abandonment etc., and in other environments, such as work-over rigs, fracking installation, well-testing installation, oil and gas production installation, without departing from the scope of the present disclosure.

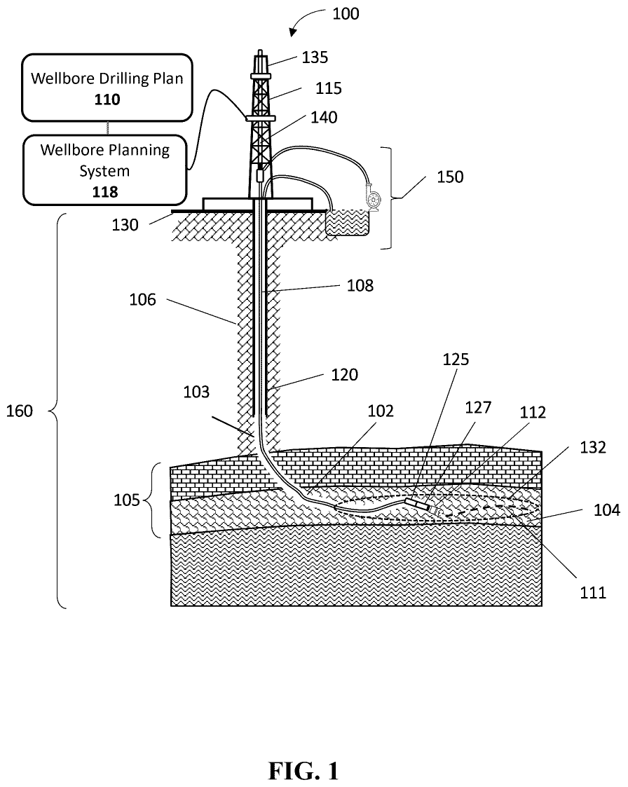

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Disclosed herein are systems and methods for constructing and operating an enhanced closed-loop geothermal system. Such methods and systems provide improvements over existing systems and methods by providing improved thermal connectivity to a geothermally heated formation and access to an increased volume of geothermal fluids. To promote heat transfer between a closed-loop geothermal system and a geothermal heat formation, an expandable casing section is used to potentially increase a volume and contact surface area of geothermal fluid accessible to a downhole heat exchanger for extracting heat. To access an increased volume of geothermal fluids, the wellbore may be enlarged along a portion of the wellbore thereby increasing the volume of geothermal fluids from which the closed-loop geothermal system extracts heat. The expandable casing section is disposed in the enlarged portions of the wellbore. The expandable casing section may be expanded to a pre-determined wellbore diameter. The combination of an enlarged portion of the wellbore and/or the use of the expandable casing section with a closed-loop geothermal system yields the enhanced closed-loop geothermal system.

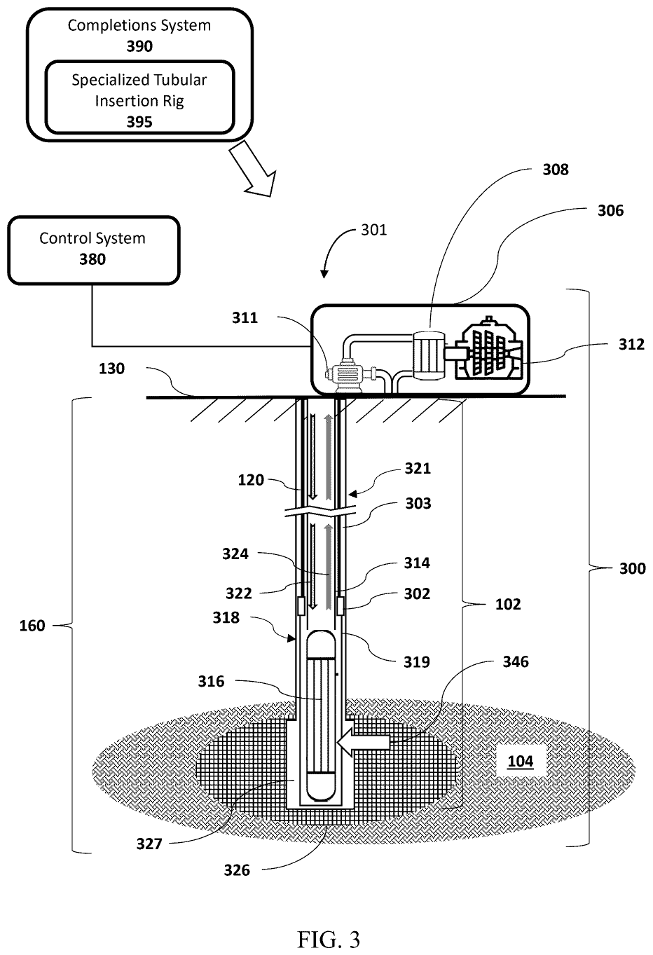

FIG. 1 illustrates a drilling system (100) that may be used to construct an enhanced closed-loop geothermal system in accordance with one or more embodiments. In some embodiments, the drilling system (100) may be configured to drill a wellbore (102) (e.g., a first wellbore and/or a second wellbore) extending from a surface (e.g., the surface of the earth) (130) and penetrating a region of a subsurface (“subsurface”) (160) guided by the wellbore drilling plan (110) that includes a wellbore path (111). The wellbore (102) extends into the subsurface (160) having a plurality of depths. Depths may be measured along the wellbore (102) yielding a measured depth (M D) or depths may be measured normal to the surface (130) yielding a total vertical depth (TV D). In some embodiments, the wellbore drilling plan (110) may be designed such that the wellbore path (111) penetrates the location of a geothermal heat source (104) within the subsurface (160). The wellbore path (111), and the resulting wellbore such as wellbore (102) may include substantially vertical portions, deviated and highly deviated portions, and horizontal portions, without departing from the scope of the invention. The wellbore (102) may be drilled in order to receive a closed-loop geothermal system such as enhanced closed-loop geothermal system (300) as described in relation to FIG. 3.

Although the drilling system (100) shown in FIG. 1 is depicted as drilling the wellbore (102) on land, the drilling system (100) may be a marine wellbore drilling system, including a jack-up rig, floating rig, semi-submersible rig, or drill-ship, without departing from the scope of the invention. Further, although the drilling system (100) shown in FIG. 1 is depicted as drilling the wellbore (102), a wellbore being drilled may be a sidetrack wellbore (not shown). As such, the example of the drilling system (100) and the location and orientation of the wellbore (102) shown in FIG. 1 is not meant to limit the disclosed and claimed invention.

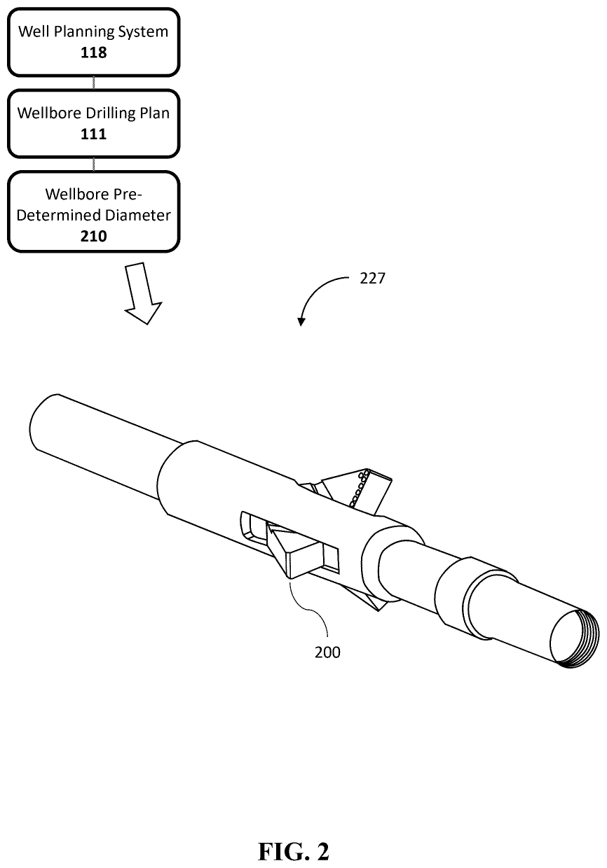

As shown in FIG. 1, the drill rig may be equipped with a hoisting system, such as a derrick (115), which can raise or lower a drillstring (108) and other tools required to drill the wellbore (102). The drillstring (108) may include one or more drill pipes connected to form a drill fluid conduit and a bottom hole assembly (BHA) (125) disposed at the distal end of the drillstring (108). The BHA (125) may include a drill bit (112) to cut into rock (106) and/or one or more formations (105) within the subsurface (160). A formation of rock such as formation (105) may include multiple layers of rock with each layer including varying rock properties (e.g., porosity, mineral composition) and or fluid properties (e.g., fluid composition) between each layer. In some embodiments, the BHA may include an enlarging system (127) operatively connected to the drill bit (112) and/or the one or more drill pipes. For example, the enlarging system (127) may include an underreamer drillstring section such as the underreamer drillstring section (227) described in relation to FIG. 2. The enlarging system (127) is configured to enlarge a wellbore diameter of a wellbore such as the wellbore (102). The enlarging system (127) enlarges the wellbore diameter relative to the diameter of the wellbore drilled by the drill bit (112). The enlarging system (127) may also smooth out wellbore walls, and/or provide a substantially uniform diameter over portions of a wellbore that the enlarging system (127) has been engaged and operated. The enlarging system (127) may also include a downhole motor (not shown), or automated rotary technology as known in the art to turn the underreamer.

In accordance with one or more embodiments, the BHA (125) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (112), the weight-on-bit, and the torque. The LWD measurements may include sensors, such as resistivity, gamma ray, and neutron density sensors, to characterize the rock (106) surrounding the wellbore (102). Both MWD and LWD measurements may be transmitted to the surface (130) using any suitable telemetry system known in the art, such as a mud-pulse or by wired-drill pipe.

To start drilling, or “spudding in,” the wellbore (102), the hoisting system lowers the drillstring (108) suspended from the derrick (115) of the drill rig towards the planned surface location of the wellbore (102). An engine, such as a diesel engine, may be used to supply power to a top drive (135) to rotate the drillstring (108) via a drive shaft (140). The weight of the drillstring (108) combined with the rotational motion enables the drill bit (112) to bore the wellbore (102).

The near-surface rock of the subsurface (160) is typically made up of loose or soft sediment or rock, so large diameter casing (e.g., “base pipe” or “conductor casing”) is often put in place while drilling to stabilize and isolate the near-surface wellbore. At the top of the base pipe is the wellhead (not shown), which serves to provide pressure control through a series of spools, valves, rams, annular, or rotating control device type precentors, or adapters. Once near-surface drilling has begun, water or drill fluid may be used to force the base pipe into place using a pumping system until the wellhead is situated just above the surface (130).

Drilling may continue without any casing once deeper or more compact rock (106) is reached. While drilling, a drilling mud system (150) may pump drilling mud from a mud tank on the surface (130) through the drill pipe. Drilling mud serves various purposes, including pressure equalization, removal of rock cuttings, and drill bit cooling and lubrication.

At planned depth intervals, drilling may be paused and the drillstring (108) withdrawn from the wellbore (102). Sections of casing may be connected forming a casing string (120). The casing string (120) is inserted and may be cemented into the wellbore (102). A casing string such as the casing string (120) may be cemented in place by pumping cement and mud, separated by a “cementing plug,” from the surface (130) through the drill pipe. The cementing plug and drilling mud force the cement through the drill pipe and into the annular space between the casing string (120) and a wall of a wellbore (102) such as wellbore wall (103). Once the cement cures, drilling may recommence. The drilling process is often performed in several stages. Therefore, the drilling and casing cycle may be repeated more than once, depending on the depth of the wellbore (102) and the pressure on the walls of the wellbore (102) from surrounding rock (106). Multiple casing strings of decreasing inner diameter may be sequentially inserted into the wellbore (102) at different phases of drilling based at least in part on the wellbore drilling plan (110). Casing inner diameter may limit the depth to which the drilling system (100) is capable of reaching. For example, a wellbore diameter may be so small that a drill bit and a drillstring are not able to be inserted for drilling. The casing inner diameter may also limit the outer diameter of components of an enhanced closed-loop geothermal system such as a downhole heat exchanger and/or fluid conduit as described in relation to FIG. 3.

Due to the high pressures experienced by deep wellbores or live well interventions, a blowout preventer (BOP) may be installed at the wellhead to protect the rig and environment from unplanned oil or gas releases. As the wellbore (102) becomes deeper, both successively smaller drill bits (112) and the casing string (120) may be used. For example, bits no smaller than 6″ and casings no smaller than 7″ may be used for optimal heat exchange and recovery. Smaller sizes result in sub-optimal circulation rates and pressure drops for production to the surface. Drilling deviated or horizontal wellbores may require specialized drill bits (112) or drill assemblies.

The drilling system (100) may be disposed at and communicate with other systems in the wellbore environment, such as a wellbore planning system (118). The drilling system (100) may control at least a portion of a drilling operation by providing controls to various components of the drilling operation. In one or more embodiments, the drilling system (100) may receive data from one or more sensors arranged to measure controllable parameters of the drilling operation. Asa non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target (132) within the geothermal heat source (104) is reached.

The direction of a wellbore may be controlled by both active and passive directional drilling (or steering). In passive directional drilling the well trajectory is determined by the flexing or buckling of the drillstring (108) in response to the application of greater or lesser weight-on-bit and the design of the BHA (125). A conventional BHA equipped with multi-stabilizers may be used to control the hole deviation angle based on the lever principle or pendulum effect. However, the resulting wellbore path is also influenced by the natural features of strength or weakness of the rock formation and so the precision with which the wellbore trajectory can be controlled may be limited.

Active directional drilling may be performed using a variety of specialized BHA and drill bits known in the art. For example, BHA components known as “bent-subs” may hold the drill bit (112) at a fixed orientation of a few degrees of deviation (typically, 1 or 2 degrees of angle) to the axis of the BHA. When the drillstring (108) is rotated the drill bit (112) bores a drilled portion of the wellbore (102) in a direction parallel to the axis of the BHA. In contrast, when the drillstring (108) is unrotated but the drill bit (112) rotated by a motor (e.g., a mud-motor or an electrical motor) then the wellbore (102) is extended in the direction of orientation and the rate of deviation of the drill bit (112). Alteratively, wellbores may be deviated using rotatory steerable devices (RSD) that use continuously adjusted pressure pads on the BHA to push or point the drill bit (112), and hence the resulting wellbore, in the desired direction. Since RSDs work with the drillstring (108) continuously rotating they are often preferred over bent-subs because of their superior drillstring drag-reduction and hole cleaning characteristics.

While FIG. 1 shows various configurations of components, other configurations may be used without departing from the scope of the disclosure. For example, various components in FIG. 1 may be combined to create a single component. As another example, the functionality performed by a single component may be performed by two or more components.

FIG. 2 shows a perspective view of the enlarging system (127) that may be used in relation to various embodiments. The enlarging system (127) may include the underreamer drillstring section (227) disposed on the drillstring (108) and configured to enlarge an inner diameter of at least a portion of a wellbore such as the wellbore (102) yielding an enlarged portion of the wellbore. The enlarging system (127) may be deployed sequentially behind the drill bit (112) along the drillstring (108). The enlarging system (127) may include one or more reamer members (200) configured to contact rock and break rock particles from a wellbore wall as the enlarging system (127) rotates. The reamer member (200), for example, may be a block member, a roller member, or may be reamer ridges. Each reamer member (200) includes a plurality of cutters that form protrusions over the reamer member (200). The cutters may be constructed of any suitable material configured to break rock from the wellbore wall (103), for example, a metal alloy, or a diamond-based material. The reamer member (200) may be configured to protrude from the enlarging system (127) to enlarge portions of a wellbore to a pre-determined wellbore diameter (210) based at least in part on the wellbore drilling plan (110). The pre-determined wellbore diameter (210) may be determined based on determining a wellbore volume configured to allow an increase of a volume of geothermal fluid in the wellbore to allow a requisite heat flow from the subsurface (160).

In accordance with one or more embodiments, the enlarging system (127) may include a specialized drill bit configured to enlarge portions of the wellbore (102) downhole of smaller diameter portions of the wellbore. The drill bit, for example, may be a bi-centered drill bit, as known in the art, configured to enlarge portions of the wellbore. Based on the disclosure herein, it will be apparent to those skilled in the art the various tools that may be employed in the enlarging system (127) for enlarging portions in the hole and the particular tools such as the underreamer drillstring section and the bi-centered drill bit should not be considered as limiting the scope of the disclosed invention.

FIG. 3 depicts an enhanced closed-loop geothermal system (300) configured to transfer heat between a downhole heat exchanger and the subsurface (160). The enhanced closed-loop geothermal system (300) includes a closed-loop geothermal system (301) and a wellbore such as the wellbore (102) extending from the surface (130), such as the surface of the earth, and penetrating into the subsurface (160) to a geothermal heat source (104). Typically, the geothermal heat source (104) will be one or more rock formations characterized by an elevated temperature that may lie at intervals to a depth of several thousand feet below the surface (130). Often the rock formation may be a volcanic pluton, solidified from molten lava injected by volcanic or tectonic forces between the surrounding rock formations, and have a low fluid permeability. The wellbore (102) may be substantially vertical, as shown, for example, in FIG. 3, or may be significantly deviated as shown, for example, in FIG. 1. The wellbore (102) may also have horizontal portions or even have portions that become shallower with increasing distance along the wellbore (102). Portions of the wellbore (102) may be enlarged yielding enlarged portions such as enlarged portion (327) of the wellbore (102). The enlarged portion (327) may be achieved using the enlarging system (127) as described in relation to FIG. 2. Based on the disclosure herein, it will be apparent to those skilled in the art that multiple portions of the wellbore (102) may be enlarged and the enlarged portions may be located anywhere along a wellbore and over any depth interval along a wellbore and that any particular enlarged portion shown is not meant to be limiting to the scope of the disclosed invention.

Portions of a wellbore may be cased, typically with steel pipe, to form “cased hole” portions such as cased hole portion (321). Typically, at least the shallowest portions of the wellbore (102) may be cased to provide mechanical stability to the wellbore (102) and/or to isolate near-surface ground water, including drinking water aquifers from fluid originating at deeper depths and/or the drilling fluids used to create the wellbore (102). Often the casing string (120) will be cemented into place, using an annular sheath of cement between the exterior surface of the casing string (120) and the rock wall of the wellbore (102). In some cases, multiple sets of casing (not shown) may be present, disposed within one another and substantially sharing a common axis. Other portions of the wellbore (102) may be left uncased to create “openhole” portions (318) of the wellbore (102). A casing string essentially isolates the interior of the cased hole portion (321) from the formation fluids in the surrounding rock formation and provides additional thermal insulation in the form of one or more layers of steel and cement. In contrast, openhole portions (318) permit fluid, including hot fluid, and heat to flow more easily into and out of the openhole portions (318).

In some embodiments, portions of the wellbore (102) may be enlarged using the enlarging system (127) before setting the casing string (120) in or across the portion. In some embodiments, an enlarged portion (e.g., a first portion) may coincide with the entire openhole portion. Another enlarged portion (e.g., a second portion) may encompass a smaller depth interval along the wellbore (102) of the openhole portion. In some embodiments, the second portion may overlap, at least partially, the first portion with the second portion having a larger diameter relative to the first portion. Any portion of the wellbore may be covered with a pre-slotted casing or production liner having one or more slots and configured to allow geothermal fluid to pass through the one or more slots. After the casing has been set, cased portions within the wellbore (102) may be left uncemented creating “uncemented” portions of the wellbore (102). The uncemented portions may coincide with one or more layers of rock, such as granite, which are more competent than other layers of rock such as shale. In some embodiments, an enlarged portion (e.g., the first portion and/or the second portion) may coincide with the entire uncemented portion. Uncemented portions permit greater heat flow from surrounding subsurface relative to cemented portions as cement acts as an insulator and does not readily allow heat convection.

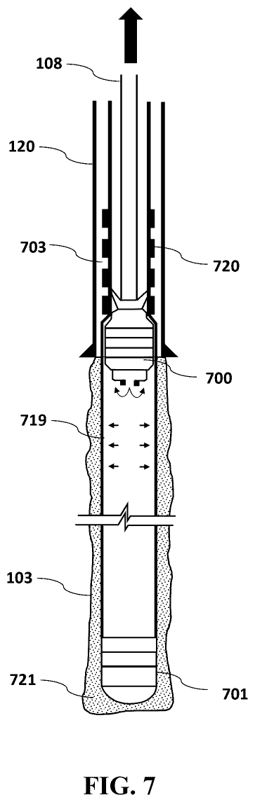

In accordance with one or more embodiments, the casing string (120) may include an expandable casing section (319) as described in relation to FIG. 7. The expandable casing section (319) is configured to expand within a portion of the wellbore (102) to form the enhanced closed-loop geothermal system (300) and which yields an expanded casing section. The expandable casing section (319) may be disposed along the casing string (120) so as to align with an enlarged portion of the wellbore (102). The expandable casing section (319) may be inserted with the casing string (120). A wellbore annulus (303) is formed between the expandable casing section (319) and the wellbore wall (103) may be filled with cement or the expandable casing section (319) may be left uncemented if disposed adjacent to competent rock. If the wellbore annulus (303) is cemented, the expandable casing section (319) may then be expanded before the cement has set. Expandable casing sections may be solid body (i.e., no holes, slots, or perforations) or pre-slotted in order to enlarge installation and usage of larger diameter tubulars. Expandable casing sections may be constructed of any suitable material such as a metal alloy that may give, for example, longer life under high temperature environments or environments with high non-compressible gas content, or other subsurface environments as known in the art.

At, near, or above the surface (130) the wellbore (102) may connect to a heat utilization facility (306). The heat utilization facility (306) may include, without limitation, one or more heat exchangers, such as an uphole heat exchanger (308) to extract heat energy from the hot working fluid (324), and/or one or more turbines, such as turbine (312) to generate electrical power. The uphole turbine(s) may be connected to the uphole heat exchanger(s) or connected directly to the tubulars configured to channel the hot working fluid (324) uphole.

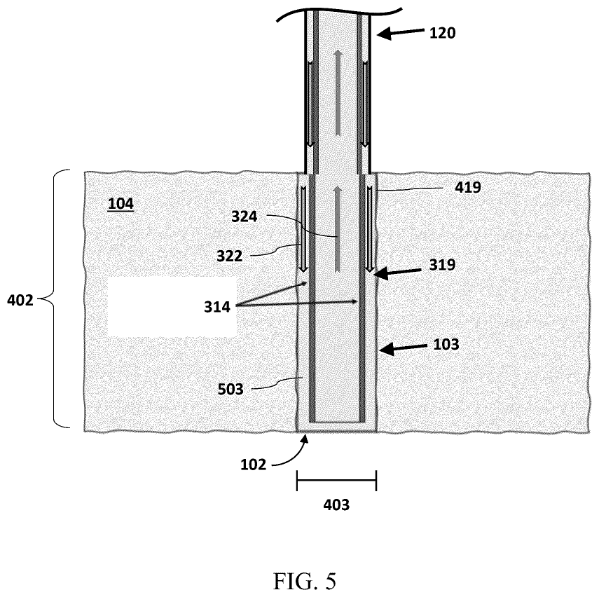

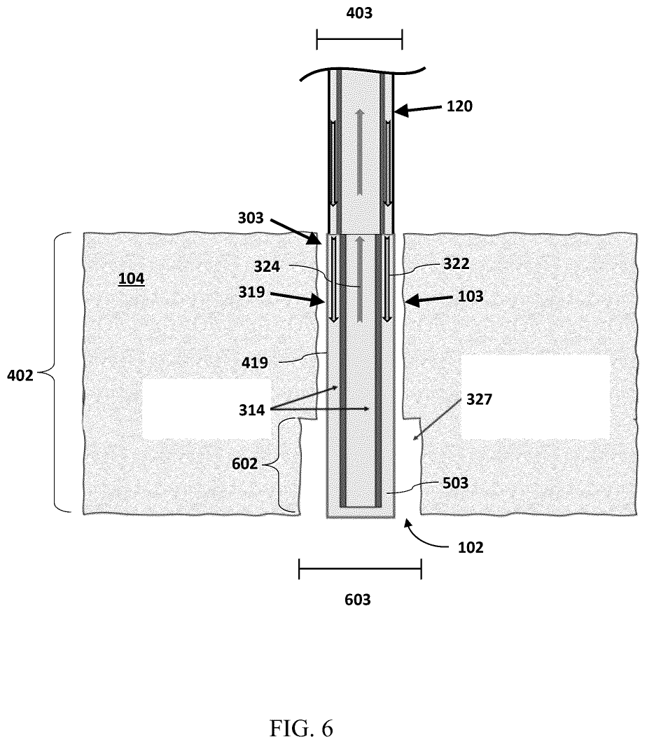

In accordance with one or more embodiments, the closed-loop geothermal system (301) includes a downhole heat exchanger (316) that may be disposed within the wellbore (102). The downhole heat exchanger (316) may function to heat a cool working fluid (322) supplied to it by transferring heat (346) from hot geothermal fluid surrounding the downhole heat exchanger (316) and producing hot working fluid (324). The fluid conduit (314) includes one or more tubulars configured to channel a cool working fluid downhole and a hot working fluid uphole. Each tubular is fluidly connected at a connection joint (302) to form the fluid conduit (314). The fluid conduit (314) must fluidically connect the downhole heat exchanger (316) with various components of the heat utilization facility (306) (e.g., the uphole heat exchanger (308)) and/or other specialized facilities (e.g., fluid processing plants) on the surface (130), and particularly with the uphole heat exchanger (308), allowing cool working fluid (322) to flow, or to be pumped, for example by uphole pump (311), downhole, and hot working fluid (324) to flow uphole. The tubulars must be configured to allow cool working fluid (322) to flow in one direction and hot working fluid (324) to flow in the opposite direction without mixing with one another. This is generally accomplished by insulating the tubulars or placing an insulated material between various pipes that form the fluid conduit (314). For example, the tubulars may be insulated (e.g., vacuum-insulated, coated, and the like) tubulars known to those skilled in the art. The fluid conduit (314) may be formed, for example, by an inner pipe within an outer pipe as shown in FIG. 5 and FIG. 6. These pipe-in-pipe tubulars allow the cool working fluid (322) to flow downhole in a conduit annulus formed between the outer pipe and the inner pipe and the hot working fluid (324) to flow uphole in the inner pipe or the cool working fluid (322) may flow downhole within the inner pipe and the hot working fluid (324) may flow uphole in the conduit annulus. Based on the disclosure herein, one skilled in the art will recognize the various configurations and types of fluid conduit compatible with the various embodiments of the disclosed invention and that the particular configuration of the fluid conduit (314) shown and described herein are not meant to limit the scope of the disclosed invention.

Cool working fluid (322) may extract heat, for example using the downhole heat exchanger (316), from the geothermal heat source (104), i.e., the hot rock formation. However, particularly in low permeability rocks the extraction of heat will cool the rock formation in a region surrounding the downhole heat exchanger (316), causing the temperature of this restricted zone (326) surrounding the downhole heat exchanger (316) to cool. Since many rocks are poor conductors of heat, and in low permeability rocks hot fluids cannot easily percolate into the restricted zone (326), the extracted heat cannot be easily replaced from more distant portions of the geothermal heat source (104) and the efficacy of the geothermal system may decrease over time. However, embodiments herein having improved thermal conductivity pathways and with careful regulation of flow, the systems herein can reach a point of near equilibrium where the decline in power generation will be very slow over the lifecycle of the well.

In some embodiments of the enhanced closed-loop geothermal system (300), a pre-existing wellbore may be used. For example, a wellbore previously drilled to provide fresh water, for geotechnical purposes, for geothermal purposes, or extended for the enhanced closed-loop geothermal system (300). In other embodiments, a wellbore such as the wellbore (102) may be drilled specifically for the construction of the enhanced closed-loop geothermal system (300) disclosed herein using a drilling system, such as drilling system (100) described in relation to FIG. 1. Based on the disclosure herein, it will be apparent to those skilled in the art that there are various configurations of an enhanced closed-loop geothermal system that may be used and the particular configuration of the enhanced closed-loop geothermal system (300) depicted in FIG. 3 should not be considered limiting to the disclosed invention.

In some embodiments, a completions system (390) may be used to insert the downhole heat exchanger (316) and the fluid conduit (314) into the wellbore (102). The completions system (390) may include a rig configured to insert the downhole heat exchanger (316) and tubulars, such as the casing string (120) and the fluid conduit (314), into the wellbore (102). In some embodiments, the completions system (390) may include a specialized tubular insertion rig (STIR) (395) configured to handle the downhole heat exchanger (316), the fluid conduit (314) and/or the casing string (120) with greater precision and gentler handling than a typical rig so as not to damage any outer surface of tubulars, such as the casing string (120) and/or the fluid conduit (314), and provide improved connections between individual tubular sections.

In some embodiments, the enhanced closed-loop geothermal system (300) may include a control system (380) configured to control various equipment and operations of the enhanced closed-loop geothermal system (300). For example, the control system (380) may be configured to operate the various heat exchangers of the closed-loop geothermal system (301) and flow control devices such as valves. As such the control system (380) may include various autonomous controllers positioned at and operatively connected to the corresponding equipment. In some embodiments, the control system (380) may be one or more computer systems, operatively connected to the equipment of the closed-loop geothermal system (301). The control system (380) may include hardware and/or software configured for performing geothermal system operations and any other specialized operations. Examples of hardware and/or software may include sensors, wires, cables, switches, routers, programmable logic controllers, microprocessors, and the like. The software may include geothermal specific software configured for sending instructions automatically and/or with user input to various equipment to perform geothermal system operations. In some embodiments, the software may also be configured to automate operations of the heat transfer system (10).

While FIG. 3 shows various configurations of components, other configurations may be used without departing from the scope of the disclosure. For example, various components in FIG. 3 may be combined to create a single component. As another example, the functionality performed by a single component may be performed by two or more components.

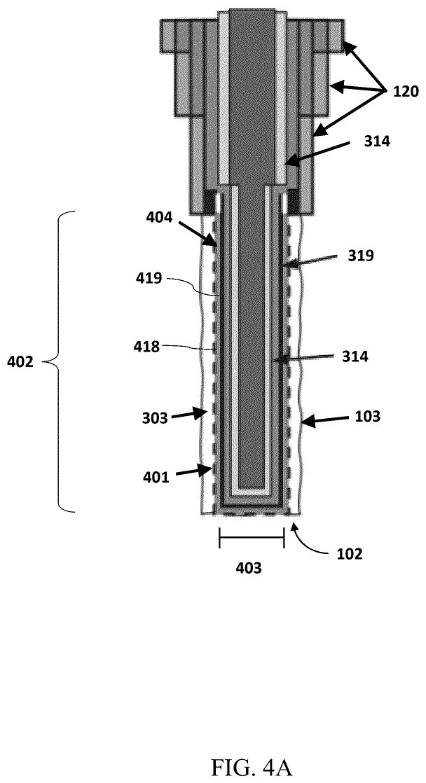

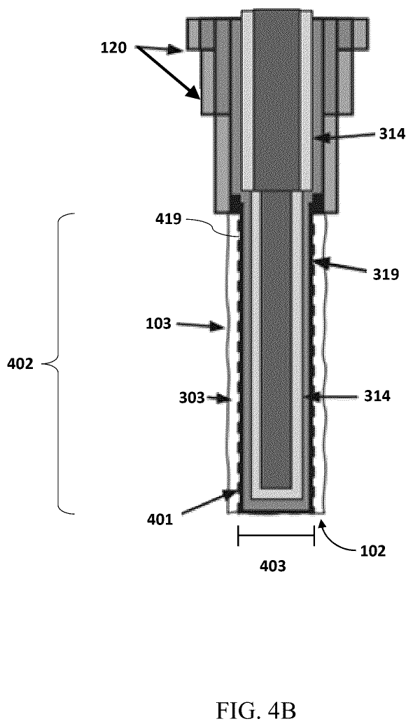

FIG. 4A depicts a partial view of the enhanced closed-loop geothermal system (300) for heat transfer using the expandable casing section (319) in accordance with one or more embodiments. The enhanced closed-loop geothermal system (300) includes a casing string that may include multiple sets of casing strings and/or liners with each sequential casing string and/or liners having decreasing diameters. Based on the disclosure herein, one of ordinary skill in the art will recognize a variety of casing string configurations that may be used in relation to different embodiments and that any particular casing string configuration described and shown herein is not meant to be limiting to the scope of the disclosed invention.

The expandable casing section (319) is disposed along the casing string (120) to align with an enlarged portion (e.g., a first portion (402) and/or a second portion (not shown)) of the wellbore (102). In some embodiments, the enlarged portion may include the entire openhole portion (318). In other embodiments, the enlarged portion may cover a partial portion of the openhole portion (318). In some embodiments, a production liner such as a pre-slotted production liner (401) may be disposed within the wellbore (102) before another casing string including the expandable casing section (319) is disposed within the wellbore (102). In some embodiments, the expandable casing section (319) may be expanded to the pre-determined wellbore diameter (210) (e.g., a first pre-determined wellbore diameter (403) and/or a second pre-determined wellbore diameter). The expandable casing section (319) may form a production annulus (404) between an outer surface (419) of the expandable casing section (319) and an inner surface (418) of the production liner.

FIG. 4B depicts a partial view of the enhanced closed-loop geothermal system (300) for heat transfer using the expandable casing section (319) in accordance with one or more embodiments. The expandable casing section (319) may be expanded to the pre-determined wellbore diameter (210) (e.g., a first pre-determined wellbore diameter (403) and/or a second pre-determined wellbore diameter). The pre-determined wellbore diameter (210) may be substantially similar to the inner diameter of the production liner. The expandable casing section (319) may be expanded until the outer surface (419) of the expandable casing section (319) substantially contacts the inner surface (418) of the production liner. In some embodiments, the expandable casing section (319) may be utilized as the outer pipe of the fluid conduit (314) as described in relation to FIG. 3. This provides a larger diameter outer pipe than is typically employed in geothermal heat production.

The enhanced closed-loop geothermal system (300) as shown in FIG. 4A and FIG. 4B permits larger tubulars inside like the insulated casing and outer string of the downhole heat exchanger (116). The closed-loop geothermal system (300) as shown in FIG. 4B has the largest possible casing inside. In this embodiment, the slotted liner may actually have larger diameter slots since the expandable and slotted liners are only separated by a relatively small gap space (e.g., 1-5 mm (⅖^{th} to 2 inches) gap space) relative to the system of FIG. 4A.

FIG. 5 depicts a partial view of the enhanced closed-loop geothermal system (300) for heat transfer including the expandable casing section (319) in accordance with one or more embodiments. A portion of the wellbore (102) may be enlarged to the first pre-determined wellbore diameter (403). In some embodiments, the drilling system (100) may circulate fluids such as mud and clean out the wellbore (102) of cuttings and rock that may have caved off of the wellbore wall (103) within the openhole portion (318). The casing string (120) having the expandable casing section (319) may be inserted into the wellbore (102). The expandable casing section (319) may cover a portion of the openhole portion (318) of the wellbore (102) or may cover the entire depth interval of the openhole portion (318) of the wellbore (102). The expandable casing section (319) is disposed along the casing string (120) so that the expandable casing section (319) is disposed into the enlarged portion of the wellbore (102). The expandable casing section (319) may be expanded until the outer surface (419) of the expandable casing section (319) substantially contacts the wellbore wall (103). The wellbore wall (103) may include one or more exposed layers of rock. The exposed layers of rock may include competent rock such as granite that may not need cement to preserve the integrity of the wellbore wall (103). In accordance with one or more embodiments, the range of surface contact with the borehole wall is from zero up to 95% contact. For example, if the expandable casing section is a solid body (i.e., is not slotted), contact with the borehole wall may be less than 15%. If the expandable casing section is slotted, contact with the borehole wall may be between 15% and 95%.

As described above, the fluid conduit (314) may include an inner pipe and an outer pipe. In some embodiments, the casing string (120) having the expandable casing section (319) may be utilized as the outer pipe of the fluid conduit (314) as described in relation to FIG. 3. This provides a larger diameter outer pipe than is typically employed in geothermal heat production. The casing string (120) having the expandable casing section (319) used as the outer pipe of the fluid conduit (314) in this scenario may be larger than typical fluid conduit since portions of the wellbore (102) has been enlarged and the expandable casing section (319) has been expanded to the pre-determined wellbore diameter (210). During operation, the cool working fluid (322) flows downhole in a conduit annulus (503) formed between the expandable casing section (319) and the inner pipe. The hot working fluid (324) flows uphole in the inner pipe of the fluid conduit (314). In some embodiments, the direction flow may be reversed so the cool working fluid (322) flows downhole through the inner pipe of the fluid conduit (314), and the hot working fluid (324) flows uphole in the conduit annulus (503) between the expandable casing section (319) and the inner pipe.

FIG. 6 depicts a partial view of the enhanced closed-loop geothermal system (300) for heat transfer using the expandable casing section (319) in accordance with one or more embodiments. A portion (e.g., the first portion (402)) of the wellbore (102) may be enlarged to the pre-determined wellbore diameter (210) (e.g., the first pre-determined wellbore diameter (403)). In some embodiments, another portion (e.g., a second portion (602)) may be further enlarged to another pre-determined wellbore diameter (e.g., the second pre-determined wellbore diameter (603). For example, the second pre-determined wellbore diameter (603) may be larger than the first pre-determined wellbore diameter (403). In some embodiments, the second portion (602) may be enlarged over a different depth interval of the wellbore (102) than the first portion (402). In some embodiments, the second portion (602) may overlap, at least partially, the first portion (402) as shown in FIG. 6. Based on the disclosure herein, it will be apparent to those skilled in the art the various configurations that are possible when enlarging different portions of a wellbore. The particular configuration shown in FIG. 6 is not meant to limit the scope of the disclosed invention.

In some embodiments, the casing string (120) having the expandable casing section (319) may be inserted into the wellbore (102). The expandable casing section (319) may cover a smaller depth interval than the entire depth interval of the openhole portion (318) of the wellbore (102) or may cover the entire depth interval of the openhole portion (318) of the wellbore (102). The expandable casing section (319) is disposed along the casing string (120) so that the expandable casing section (319) is disposed into the enlarged portion of the wellbore (102) (e.g., the first portion (402)). The expandable casing section (319) is configured to expand to the pre-determined wellbore diameter (210) (e.g., the first pre-determined wellbore diameter (403)) which yields an expanded casing section. The outer surface (419) of the expandable casing section (319) may form the wellbore annulus (303) with the wellbore wall (103).

In some embodiments, the second portion (602) may be enlarged to promote fluid circulation. For example, in various embodiments, the second pre-determined wellbore diameter (603) of the second portion (602) is larger than the first pre-determined wellbore diameter (403) of the first portion (402) and the second portion (602) overlaps some of the first portion (402). Enlarging the second portion (602) may allow for a greater volume of geothermal fluid to enter the enlarged portion (327) of the wellbore annulus (303). This provides the downhole heat exchanger (316) with greater access to the geothermal fluid in order to extract heat from the geothermal fluid within the subsurface (160).

FIG. 7 depicts the expandable casing section (319) used in the enhanced closed-loop geothermal system (300) in accordance with one or more embodiments. The expandable casing section (319) may be inserted into the wellbore (102) along with the rest of the casing string (120). The expandable casing section (319) may be inserted into the wellbore (102) using the drillstring (108) of the drilling system (100) and an expansion cone (700) which is operatively connected to the drillstring (108). The expansion cone (700) is removably attached to a terminal end (701) of the expandable casing section (319) and may be used to insert the expandable casing section (319) into the wellbore (102). The expansion cone (700) has a diameter larger than a diameter of the expandable casing section (319) before the expandable casing section (319) is expanded.

If the casing string (120) includes multiple sets of casing, the set of casing and/or the expandable casing section (319) may include one or more hanger joints (720). The hanger joint (720) is configured to seal a casing annulus (703) between different sets of casing and to suspend the set of casing from an already installed set of casing. If the hanger joint (720) is operatively disposed on the expandable casing section (319), before expansion of the expandable casing section (319), the hanger joint (720) will not be in contact with the previous set of casing. In some embodiments, the hanger joint (720) may include an elastomer, configured to expand into the external casing, giving both sealing and anchoring integrity.

After the expandable casing section (319) has been inserted into the wellbore (102), the expandable casing section (319) may be cemented. If the expandable casing section (319) is to be cemented, cement (721) is pumped downhole from the surface (130) using the drilling system (100) and process as described above. Before the cement sets, the expansion cone (700) may be disengaged from the terminal end (701) and pulled uphole using the drilling system (100). For example, an expandable casing section may be cemented as a way to facilitate larger tubular geometry uphole in a well where the thermal targeted interval is downhole from the cemented section. As the expansion cone (700) is pulled through the expandable casing section (319), the expandable casing section (319) is expanded from the expansion cone (700) being pulled through the expandable casing section (319) thereby increasing the diameter of the expandable casing section (319) and which yields an expanded casing section (719) (e.g., a first expanded casing section and/or a second expanded casing section). As the expansion cone (700) is pulled through the expandable casing section (319) where the hanger joint has been disposed, the hanger joint (720) should be operatively coupled with the previous set casing through which is the expandable casing section (319) has been inserted. In embodiments where the expandable casing section (319) is disposed next to competent rock, it may not be necessary to cement the expandable casing section (319).

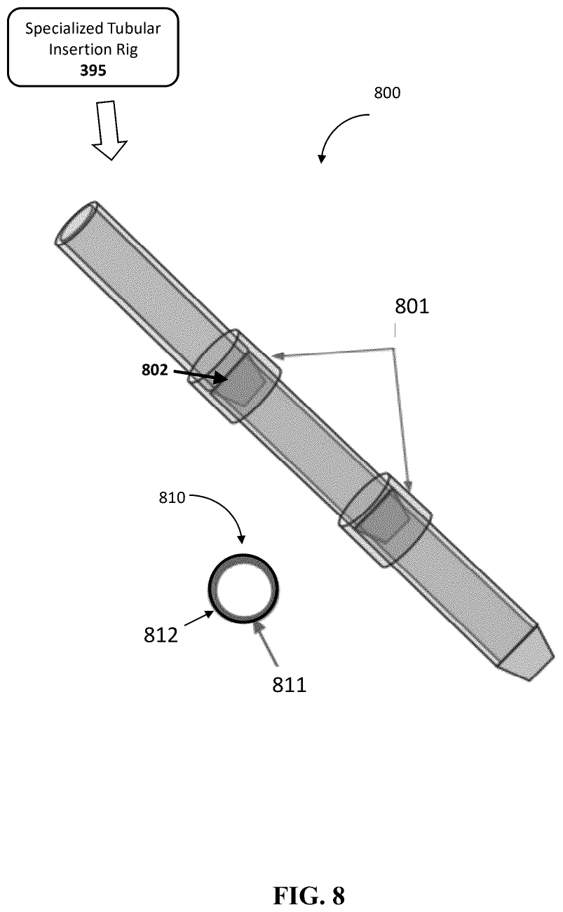

FIG. 8 depicts a partial view of a set of tubulars (800) that forms a fluid conduit such as fluid conduit 314. The set of tubulars (800) may include one or more connection sleeves (801) in accordance with one or more embodiments. The set of tubulars (800) include one or more connection joints (802) where the one or more tubulars and/or pipes of the fluid conduit (314) are operatively coupled together. The connection joint (802) may be formed using any process known to those skilled in the art such as a threaded connection, a compression connection, and/or a welding connection. In some embodiments, the set of tubulars (800) forming the fluid conduit (314) may be inserted into the expandable casing section and/or casing string (120). In some embodiments, the casing string (120) having the expandable casing section (319) may be used as the outer pipe of the fluid conduit (314) and may include the connecting sleeves (801) similar to the set of tubulars (800). Each tubular and/or pipe that forms the fluid conduit (314) and/or casing string may be insulated as shown in cross-section (810). For example, each tubular may include a vacuum-insulated tubular as known in the art. In some embodiments, the connection sleeve (801) may be disposed on each joint. The connection sleeve (801) may include an outer surface (812) and an insulating surface (811) similar to the tubulars that form the fluid conduit (314) and/or the casing string (120). The connection sleeve (801) may be operatively coupled to the fluid conduit (314) and/or the casing string (120) using any connection known in the art such as, but not limited to, threaded connection, compression connections, welding, brazing, adhesive. Each connection sleeve (801) is configured to mitigate heat loss at the joint through any connection mechanism that joins each tubular of the fluid conduit (314) and/or the casing string (120). The connection mechanism may be any connection known in the art such as, but not limited to, threaded connections, compression connections, and/or welding connections.

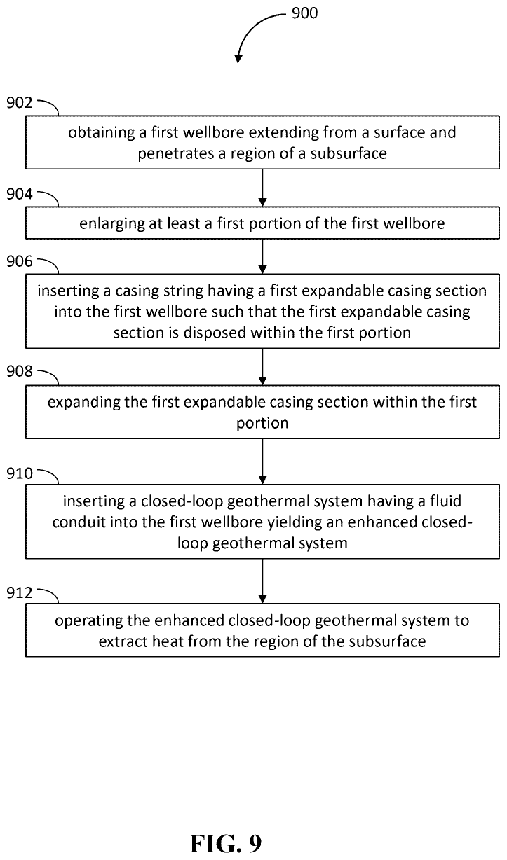

FIG. 9 is a flowchart depicting a method for constructing a system for heat transfer (hereafter “heat transfer method”) (900) in accordance with one or more embodiments. In various embodiments, the heat transfer method (900) uses the enhanced closed-loop geothermal system (300). Although the steps in the flowchart using the heat transfer method (900) are shown in sequential order, it will be apparent to one of ordinary skill in the art that some steps may be conducted in parallel, in a different order than shown, or may be omitted without departing form the scope of the invention.

In box (902), the heat transfer method (900) includes obtaining a wellbore such as wellbore (102) (e.g., a first wellbore and/or a second wellbore) extending from the surface (130) and penetrating the subsurface (160) in accordance with one or more embodiments. In some embodiments, obtaining the wellbore (102) may include obtaining a pre-existing wellbore. In some embodiments, obtaining a wellbore, such as the wellbore (102), may include obtaining a newly created wellbore using the drilling system (100). In some embodiments, the heat transfer method (900) may include obtaining the second wellbore. The first wellbore and the second wellbore may be fluidly interconnected through the subsurface (160).

In box (904), the heat transfer method (900) includes enlarging at least the first portion (402) of the first wellbore in accordance with one or more embodiments. In some embodiments, the heat transfer method (900) may include enlarging the second portion (602) of the first wellbore configured to promote fluid circulation in the second portion (602). In some embodiments, the heat transfer method (900) may include enlarging a first portion (402) of the second wellbore.

In box (906), the heat transfer method (900) includes inserting the casing string (120) having a first expandable casing section into the wellbore (102) (e.g., a first wellbore and/or a second wellbore) such that the first expandable casing section (e.g., the first expandable casing) is disposed within the first portion (402) in accordance with one or more embodiments. In some embodiments, the casing string (120) may include a second expandable casing section and may be inserted with the casing string (120) into the first wellbore such that the second expandable casing section is disposed within the second portion (602). In some embodiments, the second portion (602) may be covered by the first expandable casing section and the first expandable casing section may be expanded to the first pre-determined wellbore diameter.

In box (908), the heat transfer method (900) includes expanding the first expandable casing section within the first portion (402) to yield the expanded casing section (719) in accordance with one or more embodiments. In some embodiments, the heat transfer method (900) may include expanding the first expandable casing section until the first expandable casing section contacts a wellbore wall such as wellbore wall (103) of the wellbore (102). In some embodiments, the heat transfer method (900) may include expanding the first expandable casing section forming the wellbore annulus (303) between an outer surface of the pre-slotted expandable production liner and a wellbore wall of the first wellbore. In some embodiments, the heat transfer method (900) may include expanding the second expandable casing section within the second portion (602).

In box (910), the heat transfer method (900) includes inserting the closed-loop geothermal system (301) having the fluid conduit (314) into the first wellbore yielding an enhanced closed-loop geothermal system (300) in accordance with one or more embodiments. The fluid conduit (314) may include vacuum-insulated tubulars. Inserting the fluid conduit (314) may include inserting the fluid conduit (314) using the specialized tubular insertion rig (STIR) (395) configured to handle the tubulars of the fluid conduit (314) more gently than a typical drilling system. The STIR (395) may include hardware and software configured to provide better control in order to handle the tubulars more gently.

In box (912), the heat transfer method (900) may include operating the enhanced closed-loop geothermal system (300) to extract heat from the subsurface (160) in accordance with one or more embodiments. Economically, the enhanced closed-loop geothermal system (300) should be operated at its maximum heat production capabilities. To ensure that the enhanced closed-loop geothermal system (300) reaches this goal, the enhanced closed-loop geothermal system (300) should buffer the heat flow so that heat may flow from regions distant from a wellbore such as wellbore (102) in order to replenish heat that is being extracted from the wellbore (102) via the working fluid.

Once deployed, in accordance with one or more embodiments, the enhanced closed-loop geothermal system (300) includes the wellbore (102) extending from the surface (130) that penetrates the region of the subsurface (160). The wellbore (102) may include the first portion (402) that has been enlarged to the first pre-determined wellbore diameter (403) using the enlarging system (127). The casing string (120) includes the expanded casing section (719) that has been inserted into the wellbore (102) such that the expanded casing section (719) is disposed within the first portion (402). The expanded casing section (719) was expanded after disposition within the first portion (402). The closed-loop geothermal system (301) has been inserted into the wellbore (102). In some embodiments, the wellbore (102) includes the second portion (602) of the wellbore (102). The second portion (602) has been enlarged to the second pre-determined wellbore diameter (603). In some embodiments, the second portion (602) may overlap, at least partially, the first portion (402). In embodiments where the second portion (602) overlaps the first portion (402), the second portion (602) may be configured to promote fluid circulation in the second portion (602).

In some embodiments, the wellbore (102) may include the second portion (602) that has been enlarged to the second pre-determined wellbore diameter (603) and does not overlap the first portion (402). The casing string (120) includes the second expanded casing section. The second expanded casing section has been disposed within the second portion (602) and has been expanded within the second portion (602).

In some embodiments, the expandable casing section (319) may include the pre-slotted production liner. Expanding the expandable casing section (319) may include expanding the pre-slotted expandable production liner to the pre-determined wellbore diameter (210). In some embodiments, the heat transfer method (900) may include expanding the pre-slotted expandable production liner comprises forming the wellbore annulus (303) between an outer surface of the pre-slotted expandable production liner and the wellbore wall (103) of the wellbore (102). In some embodiments, the heat transfer method (900) may include expanding the pre-slotted expandable production liner until the pre-slotted expandable production liner contacts the wellbore wall (103) of the wellbore (102).

In some embodiments, the heat transfer method (900) may include installing an insulated the connection sleeve (801) on the connection joint (802) of the fluid conduit (314). The drilling system (100) may include connection systems configured to install the connection sleeve (801) on the connection joint (802). The connection system may include welding systems, brazing systems, handling equipment such as power tongs, and the like. In some embodiments, the STIR (395) may be used to install the connection sleeve (801) on the connection joint (802).

Embodiments of the present disclosure may provide at least one of the following advantages. The enhanced closed-loop geothermal system provides a system with greater access to an increased volume of geothermal fluids. The enhanced closed-loop geothermal system provides for a larger diameter of a wellbore than typical geothermal systems that may be enlarged along a portion of the wellbore thereby increasing the volume of geothermal fluids from which the enhanced closed-loop geothermal system extracts heat.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for constructing an enhanced closed-loop geothermal system for heat transfer from a region of a subsurface, the method comprising:
obtaining a first wellbore extending from a surface and penetrating the region of the subsurface;
enlarging at least a first portion of the first wellbore to a first pre-determined wellbore diameter;
inserting a casing string having an expandable casing section into the first wellbore such that the expandable casing section is disposed within the first portion;
expanding the expandable casing section within the first portion; and
inserting a closed-loop geothermal system having a fluid conduit into the first wellbore yielding the enhanced closed-loop geothermal system.

2. The method of claim 1, further comprising enlarging a second portion of the first wellbore to a second pre-determined wellbore diameter that overlaps, at least partially, the first portion, wherein the second portion is configured to promote fluid circulation in the second portion.

3. The method of claim 1, further comprising:
enlarging a second portion of the first wellbore to a second pre-determined wellbore diameter that does not overlap the first portion,
wherein the casing string comprises a second expandable casing section,
wherein the second expandable casing section is disposed within the second portion,
wherein the second expandable casing section is configured to expand within the second portion.

4. The method of claim 1,
wherein obtaining the first wellbore comprises obtaining a pre-existing wellbore,
wherein the expandable casing section comprises a pre-slotted expandable production liner,
wherein expanding the expandable casing section comprises expanding the pre-slotted expandable production liner to the first pre-determined wellbore diameter.

5. The method of claim 1, wherein expanding the expandable casing section comprises expanding the expandable casing section to a pre-determined wellbore diameter.

6. The method of claim 1, wherein expanding the expandable casing section comprises expanding the expandable casing section until the expandable casing section contacts a wellbore wall of the first wellbore.

7. The method of claim 1, further comprising obtaining a second wellbore, wherein the first wellbore and the second wellbore are fluidly interconnected, wherein a first portion of the second wellbore is enlarged.

8. The method of claim 1, further comprising installing an insulated connection sleeve on a connection joint of the fluid conduit.

9. A system for constructing an enhanced closed-loop geothermal system for heat transfer from a region of a subsurface, the system for constructing comprising:
a first wellbore extending from a surface and penetrating the region of the subsurface;
an enlarging system configured to enlarge at least a first portion of the first wellbore; and
an insertion rig configured to insert a casing string having an expandable casing section into the first wellbore such that the expandable casing section is disposed within the first portion,
wherein the expandable casing section is configured to expand within the first portion,
wherein the insertion rig is further configured to insert a closed-loop geothermal system having a fluid conduit into the first wellbore yielding the enhanced closed-loop geothermal system.

10. The system of claim 9, wherein the enlarging system is further configured to enlarge a second portion of the first wellbore to a second pre-determined wellbore diameter that overlaps, at least partially, the first portion, wherein the second portion is configured to promote fluid circulation in the second portion.

11. The system of claim 9,
wherein the enlarging system if further configured to enlarge a second portion of the first wellbore to a second pre-determined wellbore diameter that does not overlap the first portion,
wherein the casing string comprises a second expandable casing section,
wherein the second expandable casing section is disposed within the second portion,
wherein the second expandable casing section is configured to expand within the second portion.

12. The system of claim 9,
wherein the first wellbore comprises a pre-existing wellbore,
wherein the expandable casing section comprises a pre-slotted expandable production liner,
wherein the pre-slotted expandable production liner is configured to expand to a pre-determined wellbore diameter.

13. The system of claim 9, wherein the expandable casing section is configured to expand to a pre-determined wellbore diameter.

14. The system of claim 9, wherein the expandable casing section is configured to expand until the expandable casing section contacts a wellbore wall of the first wellbore.

15. The system of claim 9, wherein the first wellbore comprises a substantially vertical wellbore.

16. The system of claim 9, further comprising a second wellbore, wherein the first wellbore and the second wellbore are fluidly interconnected, wherein a first portion of the second wellbore is enlarged.

17. The system of claim 9, further comprising:
an insulated connection sleeve configured to be installed on a connection joint of the fluid conduit.

18. An enhanced closed-loop geothermal system for heat transfer from a region of a subsurface, the enhanced closed-loop geothermal system comprising:
a wellbore extending from a surface and penetrating the region of the subsurface;
wherein the wellbore comprises a first portion that has been enlarged to a first pre-determined wellbore diameter using an enlarging system;
a casing string having an expanded casing section that has been inserted into the wellbore such that the expanded casing section has been disposed within the first portion,
wherein the expanded casing section was expanded after disposition within the first portion; and
a closed-loop geothermal system inserted into the wellbore, the closed-loop geothermal system comprising:
an uphole heat exchanger,
a downhole heat exchanger, disposed within the wellbore, and
a fluid conduit disposed in the wellbore and configured to channel cool working fluid from the uphole heat exchanger to the downhole heat exchanger and hot fluid from the downhole heat exchanger to the uphole heat exchanger.

19. The enhanced closed-loop geothermal system of claim 18, wherein the wellbore comprises a second portion of the wellbore, wherein the second portion having been enlarged to a second pre-determined wellbore diameter and overlaps, at least partially, the first portion, wherein the second portion is configured to promote fluid circulation in the second portion.

20. The enhanced closed-loop geothermal system of claim 18,
wherein the wellbore comprises a second portion of the wellbore to a second pre-determined wellbore diameter that does not overlap the first portion,
wherein the casing string comprises a second expanded casing section,
wherein the second expanded casing section has been disposed within the second portion, and
wherein the second expanded casing section has been expanded within the second portion.
